(19) United States
(12) Patent Application Publication
(10) Pub. No.: US 2016/0150744 A1
(43) Pub. Date: Jun. 2, 2016

(54) SYSTEM AND METHOD FOR APPLYING A PESTICIDE TO A CROP

(71) Applicant: National Taiwan University, Taipei (TW)

(72) Inventors: Tzu-Shiang Lin, Taipei (TW); Joe-Air Jiang, Taipei (TW); Ming-Tzu Chiu, Taipei (TW); Shiou-Ruei Lin, Taipei (TW); Min-Sheng Liao, Taipei (TW)

(21) Appl. No.: 14/725,653

(22) Filed: May 29, 2015

(30) Foreign Application Priority Data
Nov. 27, 2014 (TW) 103141280

(51) Int. Cl. A01G 13/10; G06Q 50/02; A01M 31/00; A01M 1/02; A01M 1/20; A01M 7/00; G06Q 10/06; A01M 1/10

(52) U.S. Cl. CPC A01G 13/105; G06Q 10/06313; G06Q 50/02; A01M 1/10; A01M 1/026; A01M 1/2022; A01M 7/0089; A01M 31/002

(57) ABSTRACT

Providing a system for applying a pesticide to a crop. The system includes a trap and counter device, a data collecting platform, a data analyzing platform and a pesticide-applying control device. The trap and counter device generates an information of an insect amount, and sends the insect amount information via a communication network. The data collects platform collecting an environmental parameter information and the insect amount information via the communication network. The data analyzes platform analyzing a historical monitoring data, the environmental parameter information and the insect amount information to generate a control criterion. The pesticide-applying control device controls an amount of the pesticide to be applied to the crop based on the control criterion.

### CROSS-REFERENCE TO RELATED APPLICATION AND CLAIM OF PRIORITY

This application claims the benefit of Taiwan Patent Application No. 103141280, filed on Nov. 27, 2014, in the Taiwan Intellectual Property Office, the disclosure of which is incorporated herein in its entirety by reference.

### FIELD OF THE INVENTION

The present invention relates to a system and method of applying pesticide to a crop, particularly to an automatic pesticide-applying system and methods for applying pesticide to a crop.

### BACKGROUND OF THE INVENTION

Until recent years, crop planting was mostly based on unified operation systems, in which operations such as watering, fertilizing and pesticide-applying were performed simultaneously. However, according to research and farmers' experience, variability within a crop area often produces variation in plant growth and populations of insect pests within the area, due to different vegetation at the periphery or different topography, which affect soil moisture and soil temperature, for example.

Taking the watering system of a tea field by way of example, the traditional method of watering the tea trees used either periodic or manual control, depending on weather conditions. When watering, farmers relied on their experiences or handheld meters to determine the amount of water to be sprayed. Due to environmental parameters such as topography, wind speed and wind direction, the amount of water distributed on the tea trees was not uniform, causing variation in soil moisture and thus, tea quality. Since water supply is often scarce in the mountainous hillsides where tea trees are planted, precise control of watering and pesticide-applying may optimize the use of water resource.

In more recent years, taking advantage of the consolidation of measurement and electro-mechanical technology, automatic monitoring systems for farming have gradually replaced manual monitoring operations. Please refer to FIG. 1 illustrating an automatic monitoring system in the field 10, which includes a group of recorders 102 consisting of a first recorder 103, a second recorder 104, a third recorder 105 and a fourth recorder 106, a field router 107, an internet 12, a server 14 and a personal computer 16. The group of recorders 102 is disposed within a monitoring area 101 for monitoring the temperature and humidity information, which is later collected by the field router 107 and forwarded to the server 14 via the internet 12. A user may check the temperature and humidity information by using the person computer 16 when connected to the server 14 via the internet 12.

The automatic monitoring system illustrated in FIG. 1 determines the timing for supplying water or pesticide based on current conditions measured by monitoring data. Thus, such a system requires a watering or pesticide-supplying system which can accurately manage watering and pesticide-supplying in real time according to various topography. In addition, the amount of pest insects is closely related to the recent environment as well as climate variation. Instantaneously monitoring the amount of pest is of little use for predicting the potential soaring or reducing of the pest amount in the future, which may help proactively control the amount of pesticide supplying to the crop. Therefore, there is a need for a system and method of predicting the future amount of pest insects so as to optimize the amount of pesticide supplying to the crop.

In order to overcome the drawbacks in the prior art, a system and method of applying a pesticide to a crop is provided. The novel design in the present invention not only solves the problems described above, but also is easy to implement. Thus, the present invention has utility for the industry.

### SUMMARY OF THE INVENTION

In accordance with one aspect of the present invention, a data system for applying pesticide to a crop is described. The system includes a trap and counter device, a data collecting platform, a data analyzing platform and a pesticide-applying control device. The trap and counter device generates an information of an insect amount, and sends the insect amount information via a communication network. The data collects platform collecting an environmental parameter information and the insect amount information via the communication network. The data analyzes platform analyzing a historical monitoring data, the environmental parameter information and the insect amount information to generate a control criterion. The pesticide-applying control device controls an amount of the pesticide to be applied to the crop based on the control criterion.

In accordance with a further aspect of the present invention, a method for applying a pesticide to a crop is provided. The method comprises steps of: (a) determining there is a requirement of applying the pesticide; (b) analyzing an environmental parameter to determine a pesticide-applying mode for the crop; and (c) applying the pesticide according to the pesticide-applying mode.

In accordance with yet another aspect of the present invention, a method of applying a pesticide for a crop is provided. The method comprises steps of: (a) establishing a growth cycle database containing information of every growth stage of the crop; and (b) determining whether the crop has an insect amount exceeding a threshold amount under a specific growth stage of the crop to determine whether to initiate a pesticide-applying process.

The aforementioned objectives and advantages of the present invention will become more readily apparent to those ordinarily skilled in the art after reviewing the following detailed description and drawings, in which:

### BRIEF DESCRIPTION OF THE DRAWINGS

FIG. 1 shows a conventional automatic monitoring system in the field;

FIG. 2 is a schematic diagram of a pesticide-applying system for a crop according to an embodiment of the present invention;

FIG. 3 is a schematic diagram of a pesticide-applying method for a crop according to one embodiment of the present invention;

FIG. 4 is a schematic diagram of a real-time wind monitoring method according to another embodiment of the present invention;

FIG. 5 is a schematic diagram of a real-time wind monitoring method according to another embodiment of the present invention;

FIG. 6 is a schematic flow diagram showing a method of watering and pesticide-applying based on forecast conditions according to one embodiment of the present invention;

FIG. 7 is a schematic flow diagram showing another method of watering and pesticide-applying based on forecast conditions according to another embodiment of the present invention;

FIG. 8 is a schematic flow diagram showing yet another method of pesticide-applying to a crop according to yet another embodiment of the present invention;

FIG. 9 is a schematic flow diagram showing yet another method of pesticide-applying to a crop according to yet another embodiment of the present invention;

FIG. 10 is a schematic flow diagram showing yet another method of pesticide-applying to a crop according to yet another embodiment of the present invention.

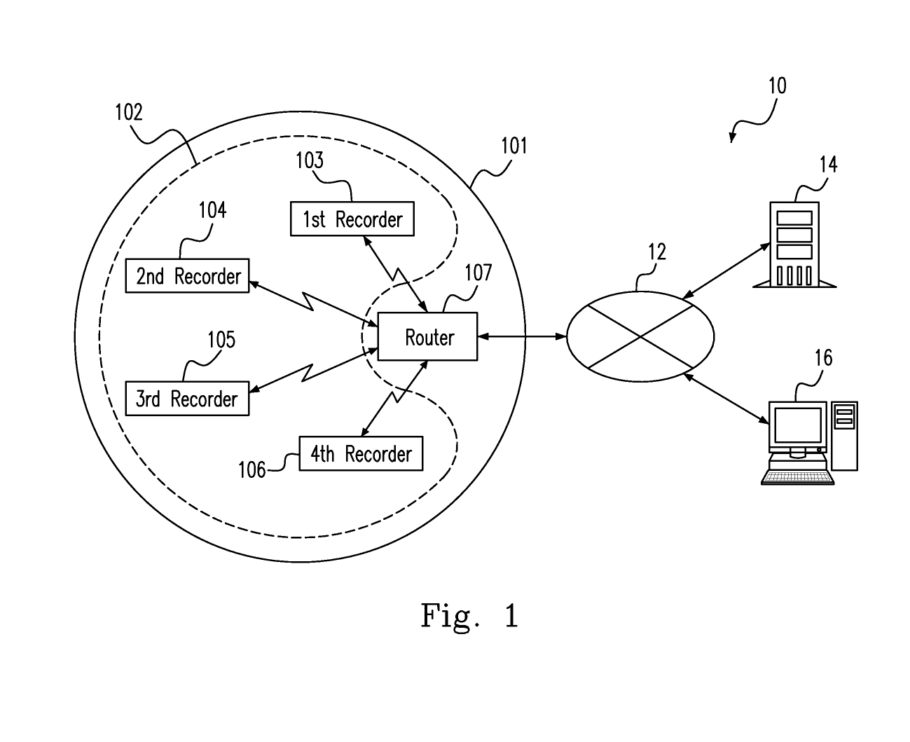

### DETAILED DESCRIPTION OF THE PREFERRED EMBODIMENT

The present invention will now be described more specifically with reference to the following embodiments. Please note that the following descriptions of preferred embodiments of this invention are presented herein for the purposes of illustration and description only; it is not intended to be exhaustive or to be limited to the precise form disclosed.

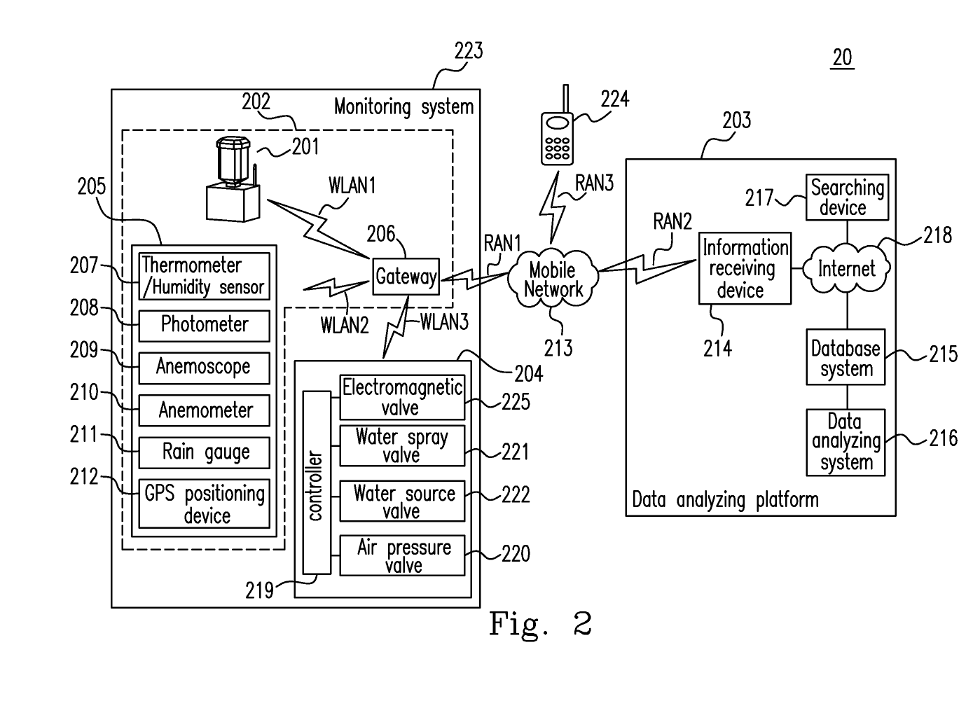

Please refer to FIG. 2, which is a schematic diagram of a pesticide-applying system for a crop according to one embodiment of the present invention. The pesticide-applying system 20 comprises an automatic trap and counter device 201, a data collecting platform 202, a data analyzing platform 203 and a pesticide-applying control device 204. The automatic trap and counter device 201 generates information of an insect amount, and sends the insect amount information via a communication network, which includes at least one of the wireless local access networks WLAN1, WLAN2, WLAN3 and the mobile networks 213, RAN1, RAN2, RAN3 illustrated in FIG. 2. According to FIG. 2, the automatic trap and counter device 201 sends information to a gateway 206. The data collecting platform 202 collects environmental parameter information and the insect amount information via the wireless local access networks WLAN2 and WLAN1, respectively. The data analyzes platform 203 analyzes a historical monitoring data, the environmental parameter information and the insect amount information to generate a control criterion (not shown). The pesticide-applying control device 204 controls an amount of the pesticide to be applied to the crop based on the control criterion.

In FIG. 2, the data collecting platform 202 further includes the automatic trap and counter device 201, and the pesticide-applying system 20 may also include a monitoring system 223, which including the data collects platform 202 and the pesticide-applying control device 204. Except for the automatic trap and counter device 201, some other types of sensors may also be utilized for monitoring the environmental parameters, and the monitoring information can be collected by the gateway 206. For example, referring to FIG. 2, the data collecting platform 202 includes the gateway 206 and a sensor device 205, which may include a thermometer/humidity sensor 207, a photometer 208, an anemoscope 209, an anemometer 210, a rain gauge 211 or a GPS positioning device 212.

The sensor device 205 senses an environmental parameter to generate the environmental parameter information and transmits the environmental parameter information via a communication network, which comprises at least one selected from a group consisting of a local area network (LAN), a wireless local access network (WLAN) and a mobile network being a radio access network (RAN). The WLAN WLAN2 illustrated in FIG. 2 is simply an example. The environmental parameter information includes at least one selected from a group consisting of instantaneous wind direction, soil temperature and moisture, instantaneous wind speed, rainfall and geographical position information. The gateway 206 periodically collects the environmental parameter information and the insect amount information via the communication network, updates the environmental parameter information and the insect amount information, and transmits the updated environmental parameter information and the updated insect amount information via the communication network such as the mobile networks RAN 1, RAN 2.

In FIG. 2, the gateway 206 collects sensing information via WLAN, since the sensor device 205, the automatic trap and counter device 201 and the gateway 206 are located at the same area and closed to each other. When the sensing information is to be transmitted to an information receiving device 214 at a remote location, the data is best transmitted via mobile networks such as RAN1, RAN2 and RAN3. The WLANs, WLAN1, WLAN2 and WLAN3, may be a wireless personal local access network (WPAN), low-rate WPAN, WiFi network, Blue-Tooth network, Zigbee and any combination thereof. The RAN network can be GSM network, GPRS, CDMA network, 3G UTRAN network, 4G LTE network, WiMAX network or any combination thereof. Those wireless networks WLAN1, WLAN2, WLAN3 and mobile networks 213, RAN1, RAN2 together constitute a wireless communication network, deployed in the field, so that the communication among the sensor device 205, the automatic trap and counter device 201 and the gateway 206 needs no wired connection, which is good for subsequent expansion of the system when necessary.

The data analyzes platform 203 includes a database system 215 periodically receiving the updated environmental parameter information and the updated insect amount information via the communication network and a data analyzing system 216 performing an analysis based on the updated environmental parameter information, the historical monitoring information and the updated insect amount information to adjust the control criterion. The data analyzes platform 203 further includes an information receive device 214 and searching device 217. In one embodiment, the database system 215 has a built-in information receiving device 214, can periodically receive the updated environmental parameter information and the updated insect information via the mobile network RAN2, and generates the control criterion based on the historical monitoring data, the updated environmental parameter information and the updated insect amount information. Since the dataflow between the database system 215 and the data analyzing system 216 could be very large, wired communication is preferred for the use thereinbetween. According to another embodiment, the gateway 206 periodically collects insect amount information and environmental parameter information from the automatic trap and counter device 201 and the sensor device 205, respectively, and transmits the information to the information receiving device 214 via the mobile networks RAN1, 213 and RAN2. The information receiving device 214 transmits the updated insect amount information and environmental parameter information to the database system 205 via the Internet 218. The searching device 217 may search the data via the Internet 218.

The present invention is particularly suitable for cropping areas having various slope and topography. Due to differences in altitude, the spray pressure should vary, and the amount and method of applying pesticide is effected by environmental parameters, such as instantaneous wind speed and direction and geographical position, which may result in non-uniform distribution of the spray. The gateway 206 can receive real-time sensing information of these environmental parameters and manage, via the WLANs WLAN1, WLAN2 and WLAN3, the pesticide-applying control device 204 so as to adjust the amount to pesticide-applying at different locations. In addition, the pesticide-applying system 20 can monitor any change in these environmental parameters during the pesticide-applying process, and determine whether to terminate the pesticide-applying process based on the system's own judgment, by which the dual purpose of intelligent management and simplicity can be achieved.

Sensing information that needs timely reaction can be received and feedback to control the pesticide-applying control device 204 via the gateway 206, while other information that needs massive calculation power for prediction can be collected by the database system 215 and then be analyzed by the data analyzing system 216 for greater efficiency. The resultant analyzed and calculated information can be used to adjust the control criterion, which can be forwarded to the gateway 206 for further control to the pesticide-applying control device 204 via the wireless communication system. Referring again to FIG. 2, the pesticide-applying control device 204 can be deployed at different areas based on requirements of the different locations. The pesticide-applying control device 204 includes an electromagnetic valve 225, a controller 219 coupled to the electromagnetic valve 225 and actuating the electromagnetic valve 225 to control the pesticide amount, an air pressure valve 220 controlling an injection of the pesticide, a water spray valve 221 controlling a spray of the pesticide, and a water source valve 222 controlling the water supply.

A mobile device 224 can be utilized to monitor the collected environmental parameters and insect amount information from the gateway 206 via the mobile network RAN3 and control the pesticide-applying control device 204 via the gateway 206. According to one embodiment, the data analyzes platform 203 overlay real-time monitoring information on a digital map, such as Google Map. For example, the user may choose to collect the environment parameter information and the insect amount information at different areas. Further, the user may search for the historical information by year, month, week or day.

In FIG. 2, the automatic trap and counter device 201 can be designed as low power-consumption model, which may include a solar power module (not shown) and a wireless communication module (not shown). The monitoring of insect amount needs to be done for a long period of time. Any change of the weather type may also influent the future number of the insect amount. Besides, prediction for the density or future number of the insect amount requires the use of an algorithm and statistical modeling, so as to generate the control criterion. According to one embodiment of the present invention, once the sensor device 205 and the automatic trap and counter device 201 respectively transmit the environmental parameter information and the insect amount to the data analyzing platform 203, which periodically analyzes the information and generates the control criterion for the monitoring system 223 disposed at each area. Having received the control criterion, the gateway 206 of the monitoring system 223 can generates a control command based on the control criterion, and set the control command into a schedule for applying pesticide.

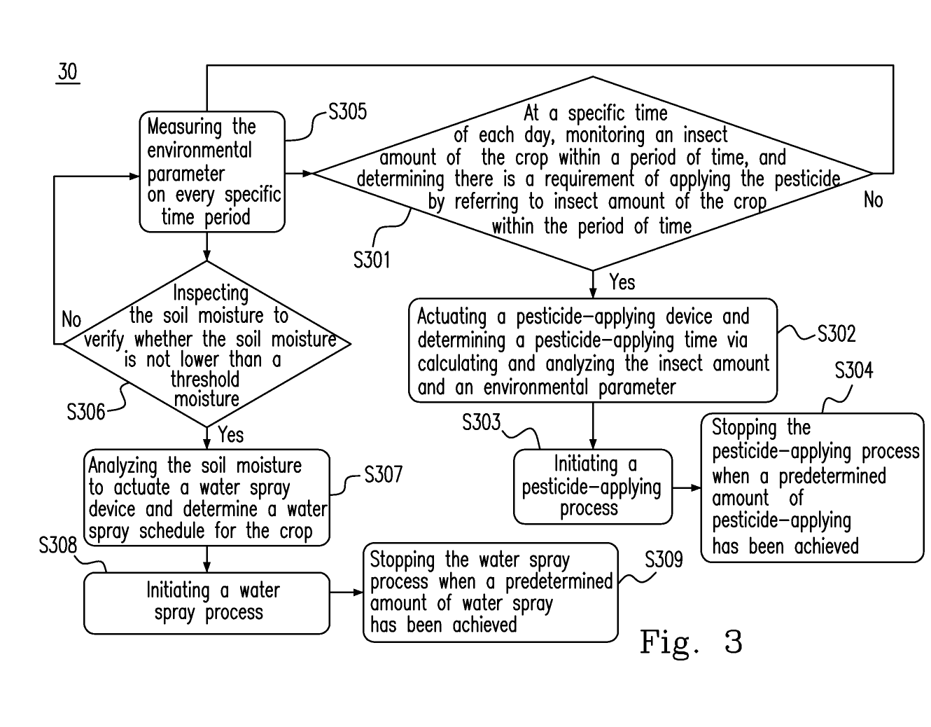

Please refer to FIG. 3, which is a schematic diagram 30 of a pesticide-applying method for a crop according to another embodiment of the present invention. The pesticide-applying method determines whether to water or apply pesticide primarily based on soil moisture and insect amount, respectively, but can also be based on custom parameters. In one embodiment, the criterion for initiating the pesticide-applying process includes: at a specific time of each day, the gateway 206 estimates the insect amount of the crop using data collected by the automatic trap and counter device 201 over a certain period of time; and the gateway 206 or the data analysis platform 203 determining there is a requirement of applying the pesticide by referring to insect amount of the crop within the period of time. In one embodiment, the criterion for initiating the water-spraying process includes: the gateway 206 measuring the soil moisture to verify whether the soil moisture is not lower than a specified threshold, which is a specific percentage. The data analysis platform 203 determines to open which of the water spray valves 221 at different locations to be actuated and how much water to be sprayed based on real-time weather conditions such as soil temperature, soil moisture, instantaneous wind direction, instantaneous wind speed and rainfall.

Please refer to FIGS. 2 and 3. The pesticide-applying method of the pesticide-applying control device 204 includes the following steps: opening the air pressure valve 220 and inserting pesticide; closing the air pressure valve 220; opening the water spray valve 221; opening the water source valve 222; actuating the electromagnetic valve 218 and controlling the amount of pesticide-applying with the electromagnetic valve 218; closing the electromagnetic valve 218 when the amount of applied pesticide has reached a predetermined value; closing the water source valve 222; actuating the electromagnetic valve 218 and controlling the amount of water-spraying with the electromagnetic valve 218; closing the electromagnetic valve 218 when the amount of sprayed water has reached a predetermined value; and closing the water source valve 222.

In Step S301, at a specific time of each day, the system monitoring an insect amount of the crop over a period of time, and determining whether there is a requirement of applying the pesticide by referring to insect amount of the crop within the period of time. If so, the system executes Step S302, and if not, go to Step S305. In Step 302, the system actuates a pesticide-applying device and determines a pesticide-applying time via calculating and analyzing the insect amount and an environmental parameter. In Step S303, the system initiates a pesticide-applying process. In Step S304, the system stops the pesticide-applying process when a predetermined amount of pesticide-applying has been achieved. In Step S305, the system measures the environmental parameter on every specific time period. In Step S306, the system inspects the soil moisture to verify whether the soil moisture is not lower than a threshold moisture. If not, return to Step S305, and if so, go to Step S307. In Step S307, the system analyzes the soil moisture to actuate a water spray device and determine a water spray schedule for the crop. In Step S308, initiating a water spray process. In Step S309, stopping the water spray process when a predetermined amount of water spay has been achieved.

Referring again to FIG. 3, step S301 may further include: measuring environmental parameter information on every specific time period when the insect amount of the crop does not exceed a threshold amount, wherein the environmental parameter information includes at least one selected from the group consisting of instantaneous wind direction, instantaneous wind speed, illumination, temperature, soil temperature, soil moisture, rainfall at a specific geographical location, pesticide amount and atmosphere pressure; and analyzing the insect amount and the environmental parameter to determine the pesticide-applying mode for the crop when the insect amount of the crop exceeds the threshold amount, wherein the pesticide-applying mode includes at least one selected from the group consisting of pesticide-applying amount, pesticide-applying period, pesticide-applying schedule, location-specific pesticide-applying device and a pesticide-applying area.

Please not that in the illustrations of FIGS. 2 and 3, the thermometer/humidity sensor measures air temperature and soil moisture, the anemoscope 209 measures instantaneous wind direction, the anemometer 210 measures instantaneous wind speed, the rain gauge 211 measures rainfall, and the gateway 206 collects all measured environmental parameter information.

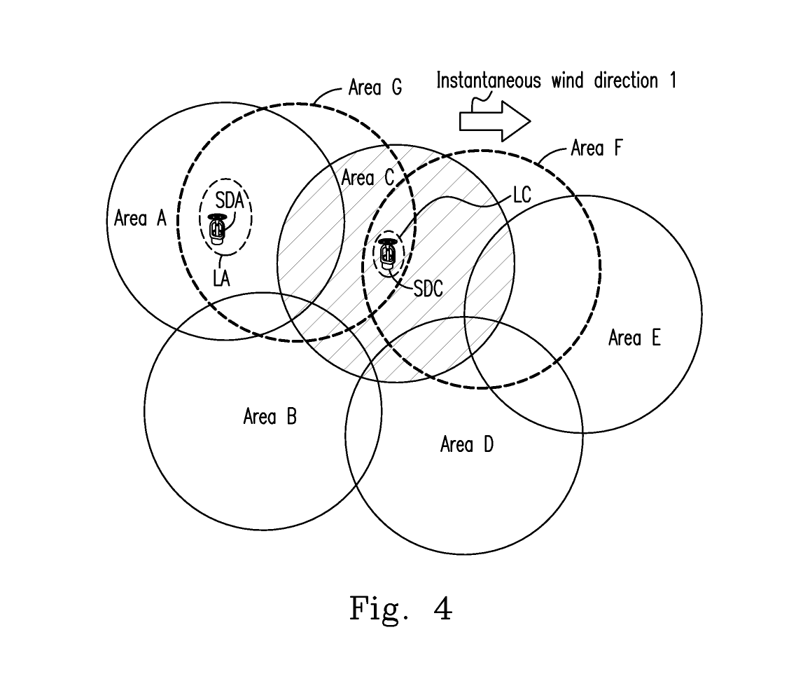

Please refer to FIG. 4, which is a schematic diagram of a real-time wind monitoring method according to another embodiment of the present invention. For different crops at different growth stage, the acceptable soil moisture varies. Thus, for the purpose of accurately determining the timing as well as volume of watering, it is necessary to establish a growth cycle database cataloging every growth stage of the crop and inspecting whether soil, on the basis of soil moisture, requires watering at the specific growth stage of the crop. It is also helpful to measure the instantaneous wind direction and wind speed and instantly generate feedback control for more effective watering.

In FIG. 4, the crop area including several areas: area A, area B, area C, area D and area E, denoted with real lines. In one embodiment, each area is equipped with at least a water spray device having a spraying coverage which is good to cover the whole area where it is located, and disposed near the center of the area. For example, the first and the second water spray devices SDC, SDA are disposed at area C, area A, and are able to water the whole areas of area C, area A, respectively. It is appreciated that the water spray device SDC is located near the center of area C. The areas G and F, denoted with dotted lines, are the actual water-sprayed location corresponding to the first and the second water spray devices SDC, SDA respectively, due to the effect of instantaneous wind along a first instantaneous wind direction 1 as the arrow shows. It can be observed that roughly half of the area of the area G overlaps with that of the area C, while nearly half of the area of the area F does not overlap with that of the area C. Thus, the area which is not covered by the area F due to the instantaneous wind along the first instantaneous wind direction 1 cannot get water from the first water spray device SDC, but can be mostly covered by the area G where the water is sprayed from the second water spraying device SDA. Therefore, in one embodiment of the present invention, both the first and the second water spray devices SDC, SDA can be actuated simultaneously to reach area C under the effect of the instantaneous wind along the first instantaneous wind direction 1, so as to compensate the instantaneous wind effect.

Please refer to FIGS. 3 and 4. According to a preferred embodiment, step S306 further includes: actuating the first water spray device SDC in a first geographic location LC to water a first area, which is the area C, when the inspected soil moisture is lower than the threshold moisture and the inspected instantaneous wind is nearly zero, which belongs to a windless status; and actuating a second water spray device SDA in a second geographic location LA to water a second area, which is the area A, without actuating the first water spray device SDC, when the inspected soil moisture is lower than the threshold moisture and the inspected instantaneous wind direction belongs to a windy status, wherein the first area and the second area, i.e. area C and area A, have an overlapping portion located at a windward position of the first area. When the instantaneous wind speed is larger, the chosen water spray device can be located at a more windward position so as to effectively water the crop.

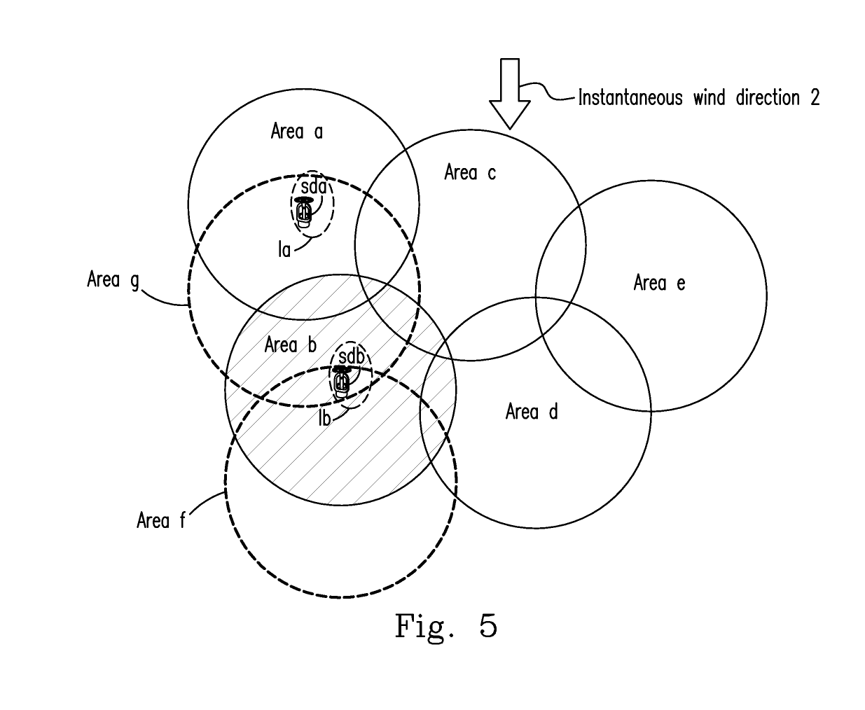

Please refer to FIG. 5, which is a schematic diagram of a real-time wind monitoring method according to another embodiment of the present invention. When the instantaneous wind direction is different, such as the instantaneous wind direction 2 illustrated in FIG. 5, the method for selecting the water spray and pesticide-applying device is similar to the aforementioned corresponding to the illustration of FIG. 4. For different crops at different growth stage, the acceptable insect amount varies. Thus, for the purpose of accurately determine the timing as well as the amount of pesticide-applying, it is necessary to establish a growth cycle database containing information of every growth stage of the crop and determining whether the insect amount exceeds a certain standard requiring pesticide application at a specific growth stage of the crop. It is also helpful to measure instantaneous wind direction and speed and instantly generate feedback control for more effective pesticide application.

In FIG. 5, the crop area includes several areas: area a, area b, area c, area d and area e, denoted with real lines. In one embodiment, each area is equipped with at least a water spray or pesticide-applying device having a spraying coverage which is good to cover the whole area where it is located, and disposed near the center of that area. For example, the first and the second pesticide-applying devices sdb, sda are disposed at area b, area a, and are able to water the whole areas of area b, area a, respectively. It is appreciated that the pesticide-applying device sdb is located near the center of area b. The areas g and f, denoted with dotted lines, are the actual pesticide-applied location corresponding to the first and the second pesticide-applying devices sdb, sda respectively, due to the effect of instantaneous wind along a second instantaneous wind direction 2 as the arrow shows. It can be observed that roughly half of the area of the area g overlaps with that of the area b, while nearly half of the area of the area f does not overlap with that of the area b. Thus, the area which is not covered by the area f due to the instantaneous wind along the second instantaneous wind direction 2 cannot get pesticide from the first pesticide-applying device sdb, but can be mostly covered by the area g where pesticide is applied from the second pesticide-applying device sda. Therefore, in one embodiment of the present invention, both the first and the second the water spray and pesticide-applying devices SDC, SDA can be actuated simultaneously to apply pesticide at the area C under the effect of the instantaneous wind along the second instantaneous wind direction 2, so as to counteract this wind effect.

Please refer to FIGS. 3 and 5. According to a preferred embodiment, the step S301 further includes: actuating a first pesticide-applying device sdb in a first geographic location lb to apply the pesticide to a first area, which is the area b, when the inspected instant wind direction belongs to a windless status; and actuating a second pesticide-applying device ada in a second geographic location la to apply the pesticide to a second area, which is the area a, without actuating the first pesticide-applying device sdb when the inspected instant wind direction belongs to a windy status, wherein the first area and the second area have an overlapping portion located at a windward position of the first area. When the instantaneous wind speed is larger, the chosen water spray and pesticide-applying device can be located at a more windward position so as to effectively apply pesticide to the crop.

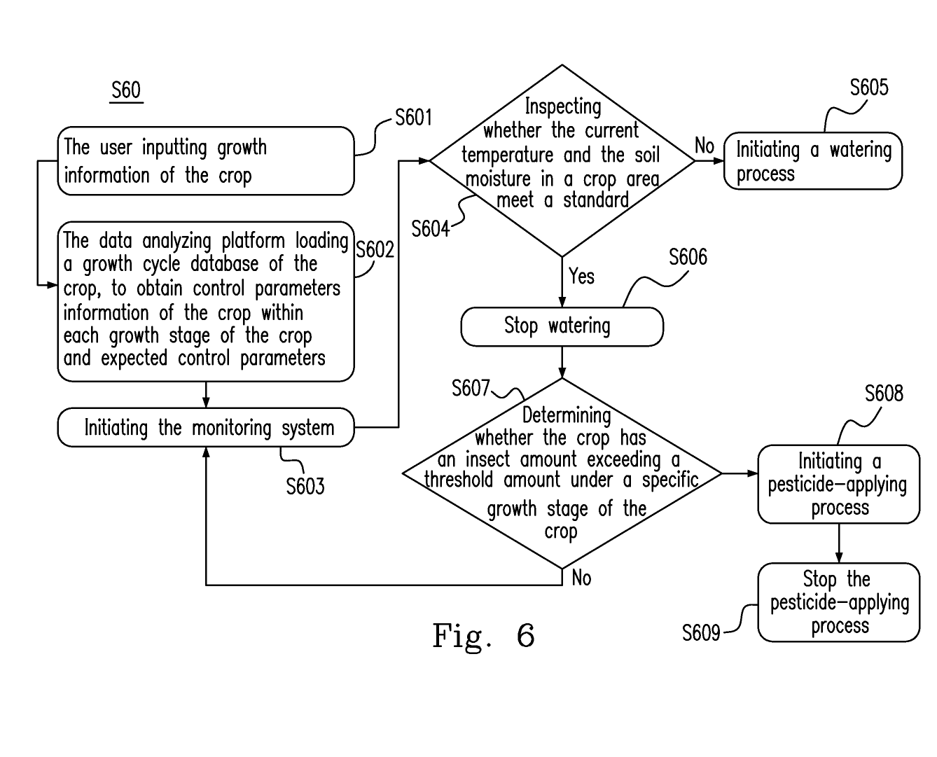

Please refer to FIG. 6, which is a flow diagram showing a method S60 of watering and pesticide-applying based on forecast conditions according to one embodiment of the present invention. The method can be implemented by the pesticide-applying system 20 for a crop in FIG. 2. First, in Step S601, the user inputting growth information of the crop. In Step S602, the data analyzing platform 203 loading a growth cycle database of the crop, to obtain control parameters within each growth stage of the crop and expected control parameters. It should be understood that these information can also be obtained from the data analyzing platform 203 by collecting the historical growth data of the crop. In Step S603, initiating the monitoring system 223. In Step S604, inspecting whether the current temperature and the soil moisture in a crop area meet a standard. If not, go to Step S605, and if so, go to Step S606. In Step 605, initiating a watering process. For example, the monitoring system 223 maintains the soil in a wet condition via monitoring and auto-control when the crop is at an early growth stage, while the monitoring system 223 maintains the soil in a dry condition when the crop is at harvest stage. In Step 606, stop watering when the soil moisture meets the standard for the growth stage of the crop.

In Step S607, determining whether the crop has an insect amount exceeding a threshold amount under a specific growth stage of the crop. If so, go to Step S608, and if not, return to Step S603. In Step S608, initiating a pesticide-applying process. In Step S609, stop the pesticide-applying process. For example, the monitoring system 223 lowers the threshold value when the crop is at early growth stage and more vulnerable to the pests, but raises the threshold value when the crop is at a later growth stage. In addition, with the input of the monitoring system 223, the data analyzing platform 203 can generate a crop growth and pest amount analytic model based on the growth cycle database and the environmental parameter, so the pesticide-applying system 20 can initiate preventive pesticide-applying when a surge of the pest amount is forecast by the crop growth and pest amount analytical model.

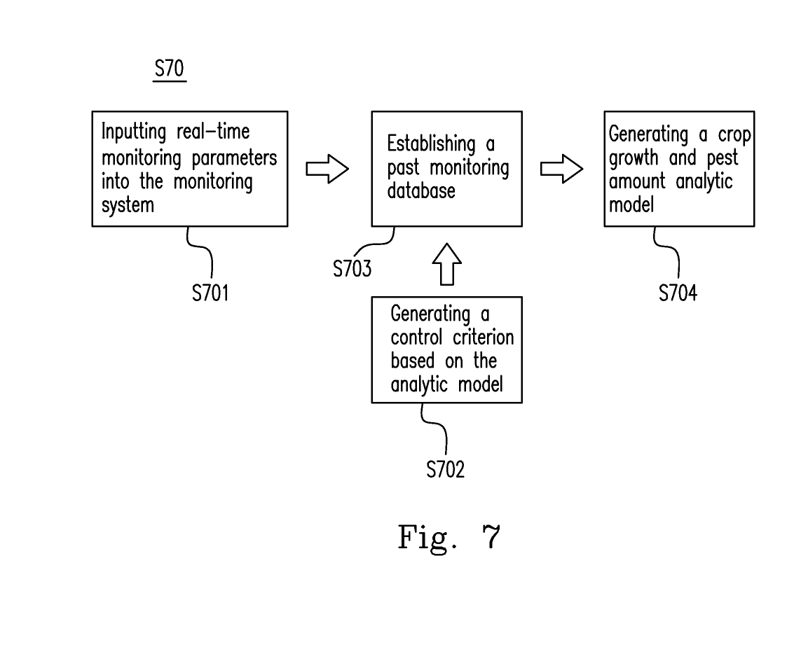

Please refer to FIG. 7, which is a flow diagram showing another method S70 of watering and pesticide-applying based on forecast conditions according to another embodiment of the present invention. In Step S701, the monitoring system 223 inputting real-time monitoring parameters into the monitoring system. The real-time monitoring parameters can be instantaneous wind direction, instantaneous wind speed, illumination, temperature, soil temperature, soil moisture, rainfall at a specific geographical location, pesticide amount or atmospheric pressure. In Step S702, establishing a historical monitoring database. In Step S703, generating a crop growth and pest amount analytic model, based on the historical monitoring database and real-time monitoring parameters. In Step S704, generating a control criterion based on the analytic model. The pesticide-applying system 20 can modify the control criterion for watering and pesticide-applying process by determining the days that the crop is advancing or lagging the specific growth stage based on the monitoring data. Furthermore, the pesticide-applying system 20 can modify the control criterion for pesticide-applying process by forecasting the increasing or decreasing of the pest amount based on the monitoring data such as the recent pest amount and environmental conditions.

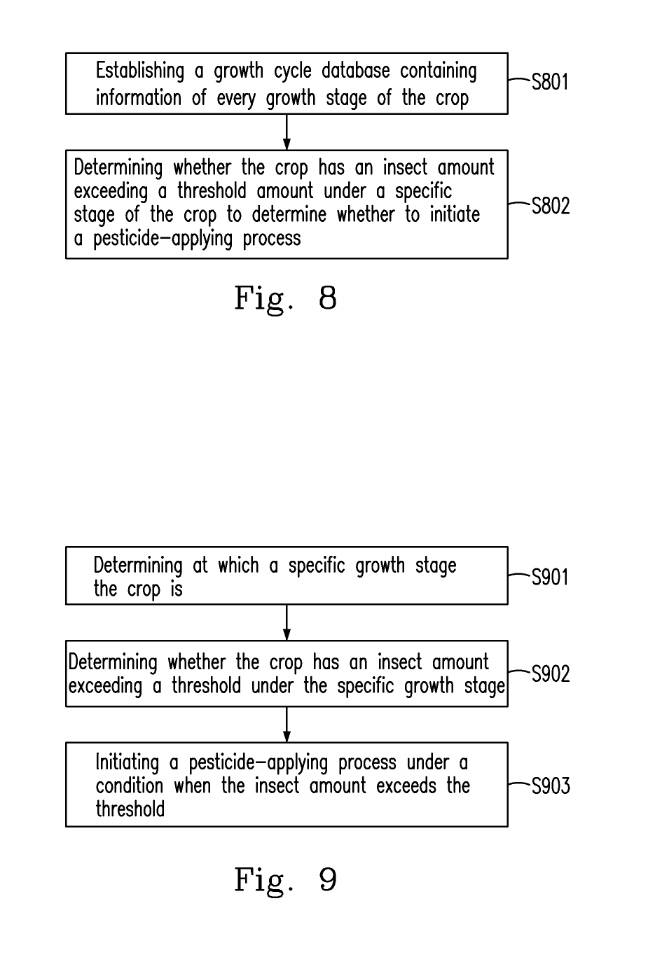

Please refer to FIG. 8, which is a flow diagram showing yet another method of pesticide-applying to a crop according to yet another embodiment of the present invention. In Step S801, establishing a growth cycle database containing information of every growth stage of the crop. In Step S802, determining whether the crop has an insect amount exceeding a threshold amount under a specific growth stage of the crop to determine whether to initiate a pesticide-applying process.

Please refer to FIG. 9, which is a flow diagram showing yet another method of pesticide-applying to a crop according to yet another embodiment of the present invention. In Step S901, determining at which a specific growth stage the crop is. In Step S902, determining whether the crop has an insect amount exceeding a threshold under the specific growth stage. In Step S903, initiating a pesticide-applying process when the insect amount exceeds the threshold.

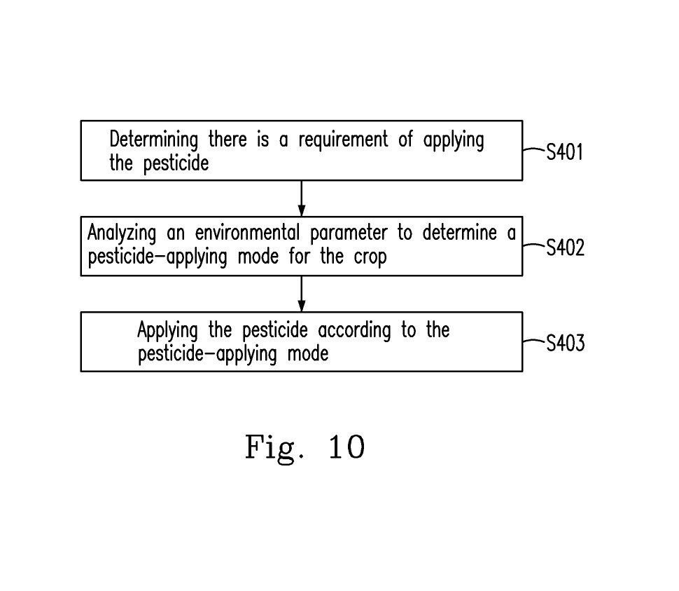

Please refer to FIG. 10, which is a schematic flow diagram showing yet another method of pesticide-applying to a crop according to yet another embodiment of the present invention. In Step S401, determining there is a requirement of applying the pesticide. In Step S402, analyzing an environmental parameter to determine a pesticide-applying mode for the crop. In Step S403, S403 applying the pesticide according to the pesticide-applying mode.

According to the descriptions set forth above, it is appreciated that, through the concepts of the present invention so as to achieve required high data processing efficiencies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

### Embodiments

1. A system for applying a pesticide to a crop, comprising: a trap and counter device generating an information of an insect amount, and sending the insect amount information via a communication network; a data collecting platform collecting an environmental parameter information and the insect amount information via the communication network; a data analyzing platform analyzing a historical monitoring data, the environmental parameter information and the insect amount information to generate a control criterion; and a pesticide-applying control device controlling an amount of the pesticide to be applied to the crop based on the control criterion.
2. The system of embodiment 1, further comprising at least one selected from a group consisting of a thermometer, a humidity sensor, a photometer, an anemoscope, an anemometer, a rain gauge and a GPS positioning device.
3. The system of embodiment 1, wherein the environmental parameter information includes at least one selected from a group consisting of instantaneous wind direction information, a soil temperature and moisture information, an instantaneous wind speed information, a rainfall information and a geographical position information.
4. The system of embodiment 1, wherein the communication network is at least one of a wired and wireless communication networks, and the historical monitoring data is an environmental climate change information.
5. The system of embodiment 1, wherein the pesticide-applying control device includes: an electromagnetic valve; a controller coupled to the electromagnetic valve and controlling the electromagnetic valve to control the pesticide amount; an air pressure valve controlling an injection of the pesticide; a water spray valve controlling a spray of the pesticide; and a water source valve controlling a water supply.
6. The system of embodiment 1, wherein the communication network includes at least one selected from a group consisting of a local area network (LAN), a wireless local access network (WLAN) and a mobile network being a radio access network (RAN).
7. The system of embodiment 1, wherein the data collecting platform includes a sensor device sensing an environmental parameter to generate the environmental parameter information and transmitting the environmental parameter information via the communication network; and a gateway periodically collecting the environmental parameter information and the insect amount information via the communication network, updating the environmental parameter information and the insect amount information, and transmitting the updated environmental parameter information and the updated insect amount information via the communication network, and wherein the data analyzing platform includes: a database system periodically receiving the updated environmental parameter information and the updated insect amount information via the communication network; and a data analyzing system performing an analysis based on the updated environmental parameter information, the historical monitoring information and the updated insect amount information to adjust the control criterion.
8. A method for applying a pesticide to a crop, the method comprising steps of: determining there is a requirement of applying the pesticide; analyzing an environmental parameter to determine a pesticide-applying mode for the crop; and applying the pesticide according to the pesticide-applying mode.
9. The method of embodiment 8, wherein the environmental parameter includes at least selected from a group consisting one of an insect amount, a soil temperature, a soil moisture, an instantaneous wind direction, an instantaneous wind speed and a rainfall, the method further comprising steps of: establishing a growth cycle database containing information of every growth stage of the crop; determining whether an insect amount of the crop exceeds a threshold amount at a specific growth stage of the crop; measuring the environmental parameter on every specific time period when the insect amount of the crop does not exceed the threshold amount; and analyzing the insect amount and the environmental parameter to determine the pesticide-applying mode for the crop when the insect amount of the crop exceeds the threshold amount, wherein the pesticide-applying mode includes at least one selected from a group consisting of a pesticide-applying amount, a pesticide-applying period, a pesticide-applying schedule, a location-specific pesticide-applying device and a pesticide-applying area.
10. The method of embodiment 9, further comprising steps of: inspecting the soil moisture; keeping inspecting the respective soil moisture on a specific time point when the soil moisture is not lower than a threshold moisture; analyzing the soil moisture to determine a water spray mode for the crop when the soil moisture is lower than the threshold moisture, wherein the water spray mode includes at least one selected from a group consisting of a water spray amount, a water spray period, a water spray schedule, a location-specific water spray device and a water spray area; and implementing a water spray according to the water spray amount and the water spray period.
11. The method of embodiment 10, wherein the water spray implementing step further comprises steps of: actuating a first water spray device in a first geographic location to water a first area when the inspected soil moisture is lower than the threshold moisture and the inspected instantaneous wind direction belongs to a windless status; and actuating a second water spray device in a second geographic location to water a second area without actuating the first water spray device when the inspected soil moisture is lower than the threshold moisture and the inspected instantaneous wind direction belongs to a windy status, wherein the first area and the second area have an overlapping portion located at a windward position of the first area.
12. The method of embodiment 8, further comprising steps of establishing a growth cycle database containing information of every growth stage of the crop; determining whether the crop has an insect amount exceeding a threshold amount under a specific growth stage of the crop; measuring an instantaneous wind direction when the insect amount exceeds the threshold amount; actuating a first pesticide-applying device in a first geographic location to apply the pesticide to a first area when the inspected instant wind direction belongs to a windless status; and actuating a second pesticide-applying device in a second geographic location to apply the pesticide to a second area without actuating the first pesticide-applying device when the inspected instant wind direction belongs to a windy status, wherein the first area and the second area have an overlapping portion located at a windward position of the first area.
13. A method of applying a pesticide for a crop, comprising steps of: establishing a growth cycle database containing information of every growth stage of the crop; and determining whether the crop has an insect amount exceeding a threshold amount under a specific growth stage of the crop to determine whether to initiate a pesticide-applying process.
14. The method of embodiment 13, further comprising a step of: detecting an environmental parameter in a crop area.
15. The method of embodiment 14, wherein the environment parameter includes at least selected from a group consisting one of an instantaneous wind direction, an instantaneous wind speed, a illumination, a temperature, a soil temperature, a soil moisture, a rainfall of a specific geographical location, a pesticide amount and an atmosphere pressure.
16. The method of embodiment 14, further comprising a step of: inspecting whether the temperature and the soil moisture meet a standard for watering under a specific growth stage of the crop to determine whether to initiate a watering process.
17. The method of embodiment 13, further comprising a step of: generating a crop growth and pest amount analytic model based on the growth cycle database and the environmental parameter.
18. The method of embodiment 17, further comprising a step of: modifying a watering criterion and a pesticide-applying criterion when the crop is in one of advancing and lagging the specific growth stage.
19. The method of embodiment 18, further comprising a step of: forecasting a future reduction/surge of the insect amount based on the insect amount and an environmental climate change to generate a predicted insect amount.
20. The method of embodiment 19, further comprising a step of: modifying the pesticide-applying criterion based on the predicted insect amount.

What is claimed is:

1. A system for applying a pesticide to a crop, comprising:
a trap and counter device generating an information of an insect amount, and sending the insect amount information via a communication network;
a data collecting platform collecting an environmental parameter information and the insect amount information via the communication network;
a data analyzing platform analyzing a historical monitoring data, the environmental parameter information and the insect amount information to generate a control criterion; and
a pesticide-applying control device controlling an amount of the pesticide to be applied to the crop based on the control criterion.

2. The system as claimed in claim 1, further comprising at least one selected from a group consisting of a thermometer, a humidity sensor, a photometer, an anemoscope, an anemometer, a rain gauge and a GPS positioning device.

3. The system as claimed in claim 1, wherein the environmental parameter information includes at least one selected from a group consisting of instantaneous wind direction information, a soil temperature and moisture information, an instantaneous wind speed information, a rainfall information and a geographical position information.

4. The system as claimed in claim 1, wherein the communication network is at least one of a wired and wireless communication networks, and the historical monitoring data is an environmental climate change information.

5. The system as claimed in claim 1, wherein the pesticide-applying control device includes:
an electromagnetic valve;
a controller coupled to the electromagnetic valve and controlling the electromagnetic valve to control the pesticide amount;
an air pressure valve controlling an injection of the pesticide;
a water spray valve controlling a spray of the pesticide; and
a water source valve controlling a water supply.

6. The system as claimed in claim 1, wherein the communication network includes at least one selected from a group consisting of a local area network (LAN), a wireless local access network (WLAN) and a mobile network being a radio access network (RAN).

7. The system as claimed in claim 1, wherein the data collecting platform includes:
a sensor device sensing an environmental parameter to generate the environmental parameter information and transmitting the environmental parameter information via the communication network; and
a gateway periodically collecting the environmental parameter information and the insect amount information via the communication network, updating the environmental parameter information and the insect amount information, and transmitting the updated environmental parameter information and the updated insect amount information via the communication network, and wherein the data analyzing platform includes:
a database system periodically receiving the updated environmental parameter information and the updated insect amount information via the communication network; and
a data analyzing system performing an analysis based on the updated environmental parameter information, the historical monitoring information and the updated insect amount information to adjust the control criterion.

8. A method for applying a pesticide to a crop, the method comprising steps of:
determining there is a requirement of applying the pesticide;
analyzing an environmental parameter to determine a pesticide-applying mode for the crop; and
applying the pesticide according to the pesticide-applying mode.

9. The method as claimed in claim 8, wherein the environmental parameter includes at least selected from a group consisting one of an insect amount, a soil temperature, a soil moisture, an instantaneous wind direction, an instantaneous wind speed and a rainfall, the method further comprising steps of:
establishing a growth cycle database containing information of every growth stage of the crop;
determining whether an insect amount of the crop exceeds a threshold amount at a specific growth stage of the crop;
measuring the environmental parameter on every specific time period when the insect amount of the crop does not exceed the threshold amount; and
analyzing the insect amount and the environmental parameter to determine the pesticide-applying mode for the crop when the insect amount of the crop exceeds the threshold amount, wherein the pesticide-applying mode includes at least one selected from a group consisting of a pesticide-applying amount, a pesticide-applying period, a pesticide-applying schedule, a location-specific pesticide-applying device and a pesticide-applying area.

10. The method as claimed in claim 9, further comprising steps of:
inspecting the soil moisture;
keeping inspecting the respective soil moisture on a specific time point when the soil moisture is not lower than a threshold moisture;
analyzing the soil moisture to determine a water spray mode for the crop when the soil moisture is lower than the threshold moisture, wherein the water spray mode includes at least one selected from a group consisting of a water spray amount, a water spray period, a water spray schedule, a location-specific water spray device and a water spray area; and
implementing a water spray according to the water spray amount and the water spray period.

11. The method as claimed in claim 10, wherein the water spray implementing step further comprises steps of:
actuating a first water spray device in a first geographic location to water a first area when the inspected soil moisture is lower than the threshold moisture and the inspected instantaneous wind direction belongs to a windless status; and
actuating a second water spray device in a second geographic location to water a second area without actuating the first water spray device when the inspected soil moisture is lower than the threshold moisture and the inspected instantaneous wind direction belongs to a windy status, wherein the first area and the second area have an overlapping portion located at a windward position of the first area.

12. The method as claimed in claim 8, further comprising steps of:
establishing a growth cycle database containing information of every growth stage of the crop;
determining whether the crop has an insect amount exceeding a threshold amount under a specific growth stage of the crop;
measuring an instantaneous wind direction when the insect amount exceeds the threshold amount;
actuating a first pesticide-applying device in a first geographic location to apply the pesticide to a first area when the inspected instant wind direction belongs to a windless status; and
actuating a second pesticide-applying device in a second geographic location to apply the pesticide to a second area without actuating the first pesticide-applying device when the inspected instant wind direction belongs to a windy status, wherein the first area and the second area have an overlapping portion located at a windward position of the first area.

13. A method of applying a pesticide for a crop, comprising steps of:
establishing a growth cycle database containing information of every growth stage of the crop; and
determining whether the crop has an insect amount exceeding a threshold amount under a specific growth stage of the crop to determine whether to initiate a pesticide-applying process.

14. The method as claimed in claim 13, further comprising a step of:
detecting an environmental parameter in a crop area.

15. The method as claimed in claim 14, wherein the environment parameter includes at least selected from a group consisting one of an instantaneous wind direction, an instantaneous wind speed, a illumination, a temperature, a soil temperature, a soil moisture, a rainfall of a specific geographical location, a pesticide amount and an atmosphere pressure.

16. The method as claimed in claim 14, further comprising a step of:
inspecting whether the temperature and the soil moisture meet a standard for watering under a specific growth stage of the crop to determine whether to initiate a watering process.

17. The method as claimed in claim 13, further comprising a step of:
generating a crop growth and pest amount analytic model based on the growth cycle database and the environmental parameter.

18. The method as claimed in claim 17, further comprising a step of:
modifying a watering criterion and a pesticide-applying criterion when the crop is in one of advancing and lagging the specific growth stage.

19. The method as claimed in claim 18, further comprising a step of:
forecasting a future reduction/surge of the insect amount based on the insect amount and an environmental climate change to generate a predicted insect amount.

20. The method as claimed in claim 19, further comprising a step of:
modifying the pesticide-applying criterion based on the predicted insect amount.
